(19) United States
(12) Patent Application Publication
(10) Pub. No.: US 2019/0135713 A1
(43) Pub. Date: May 9, 2019

(54) Automatic Matchmaking Device

(71) Applicant: Yi Yu, Cixi (CN)

(72) Inventor: Yi Yu, Cixi (CN)

(21) Appl. No.: 16/236,321

(22) Filed: Dec. 28, 2018

(30) Foreign Application Priority Data
Apr. 25, 2018 (CN) 2018103793060

(51) Int. Cl. C06F 1/02; B27L 9/00

(52) U.S. Cl. CPC C06F 1/02; B27L 9/00

(57) ABSTRACT

This invention discloses an automatic matchmaking device, comprising a machine body, a cylindrical machining cavity arranged in the machine body, a material cavity communicated with the inner wall of one end of the cylindrical machining cavity, first guide chutes communicated with the upper and lower inner walls of the material cavity, wherein the inner walls of the first guide chutes are internally communicated with second guide chutes; a first cavity disposed in the machine body, a cutting cavity communicated with the inner wall of the other end of the cylindrical machining cavity, wherein the cutting tool is periodically driven to move into the cutting cavity through a cam, a material returning outlet communicated with the inner wall of the bottom of the cutting cavity, wherein the cutting tool cuts off the matchsticks with corresponding length, and the formed matchsticks come out of the material returning outlet.

### CROSS-REFERENCES TO RELATED APPLICATIONS

The present application claims priority from Chinese application No. 2018103793060 filed on 2018 Apr. 25 which is hereby incorporated by reference in its entirety.

### TECHNICAL FIELD

The invention relates to the technical field of matchmaking, in particular to an automatic matchmaking device.

### BACKGROUND OF THE INVENTION

With the development of science and technology and the progress of society, our country always promotes the development of high technology. However, there always has been a rather difficult technical problem in the technical field of matchmaking, that is, it's hard for common matchmaking devices to finish planing because the diameter of the match is quite small. What's more, the process of continuous feeding, planing and cutting may not be synchronously completed, and separate processes are adopted, which affects the effect and efficiency of match processing, while this device solves this problem effectively.

### BRIEF SUMMARY OF THE INVENTION

The technical problem to be solved by the invention is to provide an automatic matchmaking device, so as to overcome the problems existing in the prior art.

The following technical plan is adopted by the invention: an automatic matchmaking device of this invention comprises a machine body, a cylindrical machining cavity arranged in said machine body, a material cavity with an opening towards one side communicated with the inner wall of one end of said cylindrical machining cavity, first guide chutes which are up and down symmetrical communicated with the upper and lower inner walls of said material cavity, wherein the inner walls of said first guide chutes, far away from said material cavity, are internally communicated with second guide chutes; a first cavity which penetrates through said cylindrical machining cavity disposed in said machine body, a cutting cavity communicated with the inner wall of the other end of said cylindrical machining cavity, a material returning outlet which is tilted downwards communicated with the inner wall of the bottom of said cutting cavity, second cavities which are symmetrical on the upper and lower ends of said cutting cavity arranged in said machine body, a third cavity which is on one end of said cutting cavity arranged in said machine body, wherein said cylindrical machining cavity is internally in rotational engagement with a hollow cylinder, the inner wall of which is provided with a plurality of shaping tools; a first gear which is fixedly connected to said hollow cylinder arranged in said first cavity which is internally in rotational engagement with rotating shafts which extend towards two ends and are up and down symmetrical, wherein the extending tail end of one end of said rotating shaft penetrates through said second cavity and into said third cavity and the tail end of said rotating shaft is provided with a first pulley, wherein a first belt is in power connection between two said first pulleys; wherein the extending tail end of the other end of said rotating shaft penetrates through the inner wall of one end of said second guide chute and a controlling threaded rod extending towards two ends is fixedly connected to the tail end of said rotating shaft, wherein the extending tail end of one end of said controlling threaded rod is in rotational engagement with the inner wall of said second guide chute; a second gear which is used for engaging with said first gear arranged on said rotating shaft, a cam which is located in said second cavity arranged on said rotating shaft, wherein a third guide chute is communicated between said second cavity and said cutting cavity, wherein said third guide chute is internally in sliding fit connection with a cutting tool, one end of which, close to second cavity, extends into said second cavity and is in power connection with said cam; an elastic recovery device arranged on one end of said cutting tool; cyclic material-feeding devices, used for being in power connection with said controlling threaded rods, respectively disposed in said material cavity, said first guide chutes and said second guide chute and a dust extracting device arranged on one end face of said machine body.

As an optimized technical proposal, the inside diameter of said shaping tool and the diameter of said cutting cavity are the same, which improves the matchmaking effect of the device.

As an optimized technical proposal, said elastic recovery device comprises a fourth guide chute communicated with one end of said third guide chute, wherein said fourth guide chute is internally in rotational engagement with a first guide slider, wherein one end face of first guide slider is fixedly connected to one end face of said cutting tool, a first pushing spring which is located on the bottom of said first guide slider arranged in said fourth guide chute, so that the material may be orderly cut off.

As an optimized technical proposal, said cyclic material-feeding device comprises a second guide slider which extends up and down and is in sliding fit connection with said second guide chute, wherein said second guide slider is in threaded fit connection with said controlling threaded rod; a cyclic dragging ring which is located on one end of said hollow cylinder fixedly connected between two said second guide sliders, a fifth guide chute which is located in said first guide chute arranged to penetrate through said second guide slider from one side to the other side, a push rod which extends up and down and is in sliding fit connection between said fifth guide chute and said cyclic dragging ring, wherein one end of said push rod, close to said fifth guide chute, is fixedly connected with a third guide slider which is in sliding fit connection with said push rod, wherein a second pushing spring is arranged between said third guide slider and the inner wall of said fifth guide chute, close to said cyclic dragging ring, wherein one end of said push rod, close to said cyclic dragging ring, extends into interior of said cyclic dragging ring and the tail end of said push rod is provided with an arc clamp; a fourth guide slider which penetrates through said fifth guide chute and is in sliding fit connection with said first guide chute, wherein said fourth guide slider is in sliding fit connection with said third guide slider; a fifth guide slider which is located on one end of said second guide slider and extends up and down and is in sliding fit connection with said first guide chute, wherein one end of said fifth guide slider, close to said fourth guide slider, is fixedly connected to said fourth guide slider; slide clamps arranged on the end faces of said fifth guide slider, close to each other, an impeller which is used for being in power connection with said fourth guide slider embedded in the inner wall of said first guide chute, far away from said material cavity, which improves the work efficiency of the device.

As an optimized technical proposal, the top of said machine body is provided with a fixed block, one end face of which is embedded with a motor, wherein one tail end of said motor is in power connection with a second pulley which is located on the top of said third cavity, wherein a second belt is in power connection between said second pulley and said first pulley.

As an optimized technical proposal, the inside diameter of said hollow cylinder is the same as that of said cyclic dragging ring.

As an optimized technical proposal, said dust extracting device comprises a dusting machine body which is set on one end face of said machine body, wherein said dusting machine body is internally provided with a sliding chute with an opening towards one side, wherein said sliding chute is internally in sliding fit connection with a slider, one end face of which is provided with a dust catcher; a second controlling threaded rod which extends towards two ends disposed on said slider, a fourth motor in power connection with one tail end of said second controlling threaded rod, wherein the outer surface of said fourth motor is embedded in the inner wall of one end of said sliding chute and is fixedly connected to said sliding chute.

The benefits of the invention are as follows: when the device of this invention is in the initial state, said cutting tool is fully contracted into said third guide chute, and said first guide slider is located on the one end of said fourth guide chute, far away from said cutting cavity, and said second guide slider is located on one tail end of said second guide chute, and said fourth guide slider is located at the top of said first guide chute. At the same time, said fourth guide slider is located on the top of said fifth guide chute, and said third guide slider abuts against said fourth guide slider, and said push rod extends to a maximum extent into said fifth guide chute. At the moment, said arc clamp is in contact with the internal cavity of said cyclic dragging ring, and said slide clamp and said arc clamp are in the same straight line, which is convenient for maintenance and feeding.

When matchmaking is carried out by using the device of this invention, the round bars to be machined are firstly placed into said cyclic dragging ring, and at the moment said impeller is started to push said fourth guide sliders to move towards each other, and said fourth guide sliders make said arc clamp and said slide clamp tightly clamp the round bars simultaneously; at this moment, one tail end of the round bar extends into said hollow cylinder, and then said motor is started to drive two said rotating shafts to rotate in the same direction to drive said cam, said second gear and said controlling threaded rod to rotate simultaneously. Said cam drives said cutting tool to move periodically into said cutting cavity, and said second gear drives said first gear to rotate to drive said hollow cylinder to rotate. Meanwhile, said controlling threaded rod drives said second guide slider and said cyclic dragging ring as a whole to move to one end, and internally clamped round bars are successively pushed into said cyclic dragging ring, and said shaping tools in said hollow cylinder are started to shape the round bars. As said cyclic dragging ring is moved to one tail end of said material cavity, said cutting tool cuts off the matchsticks with corresponding length, and the formed matchsticks come out of said material returning outlet, which improves the matchmaking effect.

When the further feeding is needed, said impeller is firstly controlled to contract, and said fourth guide slider, said fifth guide slider and said third guide slider are recovered to the initial position under the action of second pushing spring, which makes said arc clamp and said slide clamp move away from each other and release the round bars, and then said motor is controlled to drive said rotating shaft to rotate reversely, and at this time said rotating shaft still drives said cutting tool and said hollow cylinder to operate, while said rotating shaft drives said controlling threaded rod which rotates reversely to make said second guide slider and said cyclic dragging ring as a whole move to the other end and recover to the initial position. Then said impeller is sequentially controlled to clamp the round bars tightly, and finally said motor is controlled to recover to rotate forward. In conclusion, reciprocating matchmaking may be realized by circulating operations above, which improves the efficiency and practical performance of the matchmaking.

The device of this invention has a simple structure and is convenient to use as it uses the same power source to realize the automatic and circulating feeding, planing operation and automatic and accurate material cutting, and all the processes are closely coordinated but not to affect their separate operation. Moreover, this device is high in automatic degree, good in matchmaking effect and saves wood, and meanwhile, the practical performance of the device is greatly improved.

### BRIEF DESCRIPTION OF THE DRAWINGS

For better description, the present invention is described in detail by the following specific embodiments and drawings.

FIG. 1 is a schematic diagram depicting an overall configuration inside an automatic matchmaking device of this invention.

### DETAILED DESCRIPTION OF THE INVENTION

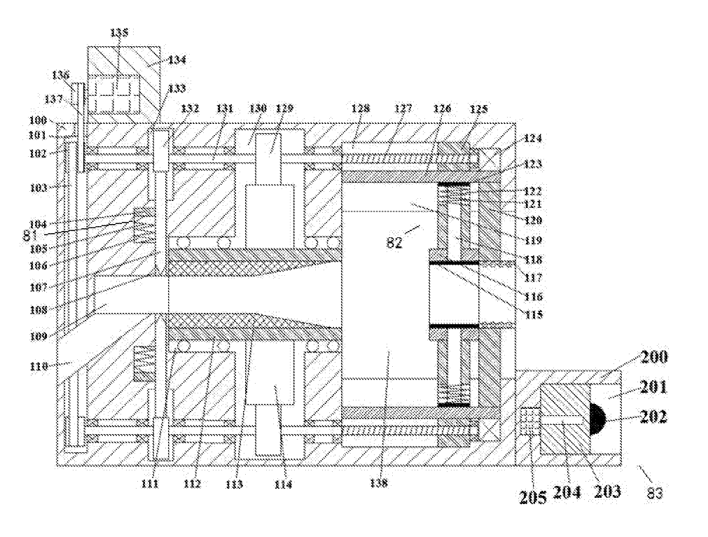

Referring to FIG. 1, an automatic matchmaking device of this invention comprises a machine body 100, a cylindrical machining cavity 111 arranged in said machine body 100, a material cavity 138 with an opening towards one side communicated with the inner wall of one end of said cylindrical machining cavity 111, first guide chutes 119 which are up and down symmetrical communicated with the upper and lower inner walls of said material cavity 138, wherein the inner walls of said first guide chutes 119, far away from said material cavity 138, are internally communicated with second guide chutes 128; a first cavity 130 which penetrates through said cylindrical machining cavity 111 disposed in said machine body 100, a cutting cavity 109 communicated with the inner wall of the other end of said cylindrical machining cavity 111, a material returning outlet 110 which is tilted downwards communicated with the inner wall of the bottom of said cutting cavity 109, second cavities 133 which are symmetrical on the upper and lower ends of said cutting cavity 109 arranged in said machine body 100, a third cavity 101 which is on one end of said cutting cavity 109 arranged in said machine body 100, wherein said cylindrical machining cavity 111 is internally in rotational engagement with a hollow cylinder 112, the inner wall of which is provided with a plurality of shaping tools 113; a first gear 114 which is fixedly connected to said hollow cylinder 112 arranged in said first cavity 130 which is internally in rotational engagement with rotating shafts 131 which extend towards two ends and are up and down symmetrical, wherein the extending tail end of one end of said rotating shaft 131 penetrates through said second cavity 133 and into said third cavity 101 and the tail end of said rotating shaft 131 is provided with a first pulley 102, wherein a first belt 103 is in power connection between two said first pulleys 102; wherein the extending tail end of the other end of said rotating shaft 131 penetrates through the inner wall of one end of said second guide chute 128 and a controlling threaded rod 127 extending towards two ends is fixedly connected to the tail end of said rotating shaft 131, wherein the extending tail end of one end of said controlling threaded rod 127 is in rotational engagement with the inner wall of said second guide chute 128; a second gear 129 which is used for engaging with said first gear 114 arranged on said rotating shaft 131, a cam 132 which is located in said second cavity 133 arranged on said rotating shaft 131, wherein a third guide chute 108 is communicated between said second cavity 133 and said cutting cavity 109, wherein said third guide chute 108 is internally in sliding fit connection with a cutting tool 107, one end of which, close to said second cavity 133, extends into said second cavity 133 and is in power connection with said cam 132; an elastic recovery device 81 arranged on one end of said cutting tool 107; cyclic material-feeding devices 82, used for being in power connection with said controlling threaded rods 127, respectively disposed in said material cavity 138, said first guide chutes 119 and said second guide chute 128; a dust extracting device 83 arranged on one end face of said machine body 100.

Beneficially, the inside diameter of said shaping tool 113 and the diameter of said cutting cavity 109 are the same, which improves the matchmaking effect of the device.

Beneficially, said elastic recovery device 81 comprises a fourth guide chute 106 communicated with one end of said third guide chute 108, wherein said fourth guide chute 106 is internally in rotational engagement with a first guide slider 104, wherein one end face of first guide slider 104 is fixedly connected to one end face of said cutting tool 107, a first pushing spring 105 which is located on the bottom of said first guide slider 104 arranged in said fourth guide chute 106, so that the material may be orderly cut off.

Beneficially, said cyclic material-feeding device 82 comprises a second guide slider 125 which extends up and down and is in sliding fit connection with said second guide chute 128, wherein said second guide slider 125 is in threaded fit connection with said controlling threaded rod 127; a cyclic dragging ring 116 which is located on one end of said hollow cylinder 112 fixedly connected between two said second guide sliders 125, a fifth guide chute 122 which is located in said first guide chute 119 arranged to penetrate through said second guide slider 125 from one side to the other side, a push rod 118 which extends up and down and is in sliding fit connection between said fifth guide chute 122 and said cyclic dragging ring 116, wherein one end of said push rod 118, close to said fifth guide chute 122, is fixedly connected with a third guide slider 123 which is in sliding fit connection with said push rod 118, wherein a second pushing spring 121 is arranged between said third guide slider 123 and the inner wall of said fifth guide chute 122, close to said cyclic dragging ring 116, wherein one end of said push rod 118, close to said cyclic dragging ring 116, extends into interior of said cyclic dragging ring 116 and the tail end of said push rod 118 is provided with an arc clamp 115; a fourth guide slider 126 which penetrates through said fifth guide chute 122 and is in sliding fit connection with said first guide chute 119, wherein said fourth guide slider 126 is in sliding fit connection with said third guide slider 123; a fifth guide slider 120 which is located on one end of said second guide slider 125 and extends up and down and is in sliding fit connection with said first guide chute 119, wherein one end of said fifth guide slider 120, close to said fourth guide slider 126, is fixedly connected to said fourth guide slider 126; slide clamps 117 arranged on the end faces of said fifth guide sliders 120, close to each other, an impeller 124 which is used for being in power connection with said fourth guide slider 126 embedded in the inner wall of said first guide chute 119, far away from said material cavity 138, which improves the work efficiency of the device.

Beneficially, the top of said machine body 100 is provided with a fixed block 134, one end face of which is embedded with a motor 135, wherein one tail end of said motor 135 is in power connection with a second pulley 136 which is located on the top of said third cavity 101, wherein a second belt 137 is in power connection between said second pulley 136 and said first pulley 102.

Beneficially, the inside diameter of said hollow cylinder 112 is the same as that of said cyclic dragging ring 116.

Beneficially, said dust extracting device 83 comprises a dusting machine body 200 which is set on one end face of said machine body 100, wherein said dusting machine body 200 is internally provided with a sliding chute 201 with an opening towards one side, wherein said sliding chute 201 is internally in sliding fit connection with a slider 203, one end face of which is provided with a dust catcher 202; a second controlling threaded rod 204 which extends towards two ends disposed on said slider 203, a fourth motor 205 in power connection with one tail end of said second controlling threaded rod 204, wherein the outer surface of said fourth motor 205 is embedded in the inner wall of one end of said sliding chute 201 and is fixedly connected to said sliding chute 201.

When the device of this invention is in the initial state, said cutting tool 107 is fully contracted into said third guide chute 108, and said first guide slider 104 is located on the one end of said fourth guide chute 106, far away from said cutting cavity 109, and said second guide slider 125 is located on one tail end of said second guide chute 128, and said fourth guide slider 126 is located at the top of said first guide chute 119. At the same time, said fourth guide slider 126 is located on the top of said fifth guide chute 122, and said third guide slider 123 abuts against said fourth guide slider 126, and said push rod 118 extends to a maximum extent into said fifth guide chute 122. At the moment, said arc clamp 115 is in contact with the internal cavity of said cyclic dragging ring 116, and said slide clamp 117 and said arc clamp 115 are in the same straight line.

When matchmaking is carried out by using the device of this invention, the round bars to be machined are firstly placed into said cyclic dragging ring 116, and at the moment said impeller 124 is started to push said fourth guide sliders 126 to move towards each other, and said fourth guide sliders 126 make said arc clamp 115 and said slide clamp 117 tightly clamp the round bars simultaneously; at this moment, one tail end of the round bar extends into said hollow cylinder 112, and then said motor 135 is started to drive two said rotating shafts 131 to rotate in the same direction to drive said cam 132, said second gear 129 and said controlling threaded rod 127 to rotate simultaneously. Said cam 132 drives said cutting tool 107 to move periodically into said cutting cavity 109, and said second gear 129 drives said first gear 114 to rotate to drive said hollow cylinder 112 to rotate. Meanwhile, said controlling threaded rod 127 drives said second guide slider 125 and said cyclic dragging ring 116 as a whole to move to one end, and internally clamped round bars are successively pushed into said cyclic dragging ring 116, and said shaping tools 113 in said hollow cylinder 112 are started to shape the round bars. As said cyclic dragging ring 116 is moved to one tail end of said material cavity 138, said cutting tool 107 cuts off the matchsticks with corresponding length, and the formed matchsticks come out of said material returning outlet 110.

When the further feeding is needed, said impeller 124 is firstly controlled to contract, and said fourth guide slider 126, said fifth guide slider 120 and said third guide slider 123 are recovered to the initial position under the action of second pushing spring 121, which makes said arc clamp 115 and said slide clamp 117 move away from each other and release the round bars, and then said motor 135 is controlled to drive said rotating shaft 131 to rotate reversely; at this time said rotating shaft 131 still drives said cutting tool 107 and said hollow cylinder 112 to operate, while said rotating shaft 131 drives said controlling threaded rod 127 which rotates reversely to make said second guide slider 125 and said cyclic dragging ring 116 as a whole move to the other end and recover to the initial position. Then said impeller 124 is sequentially controlled to clamp the round bars tightly, and finally said motor 135 is controlled to recover to rotate forward. In conclusion, reciprocating matchmaking may be realized by circulating operations above.

The benefits of the invention are as follows: when the device of this invention is in the initial state, said cutting tool is fully contracted into said third guide chute, and said first guide slider is located on the one end of said fourth guide chute, far away from said cutting cavity, and said second guide slider is located on one tail end of said second guide chute, and said fourth guide slider is located at the top of said first guide chute. At the same time, said fourth guide slider is located on the top of said fifth guide chute, and said third guide slider abuts against said fourth guide slider, and said push rod extends to a maximum extent into said fifth guide chute. At the moment, said arc clamp is in contact with the internal cavity of said cyclic dragging ring, and said slide clamp and said arc clamp are in the same straight line, which is convenient for maintenance and feeding.

When matchmaking is carried out by using the device of this invention, the round bars to be machined are firstly placed into said cyclic dragging ring, and at the moment said impeller is started to push said fourth guide sliders to move towards each other, and said fourth guide sliders make said arc clamp and said slide clamp tightly clamp the round bars simultaneously; at this moment, one tail end of the round bar extends into said hollow cylinder, and then said motor is started to drive two said rotating shafts to rotate in the same direction to drive said cam, said second gear and said controlling threaded rod to rotate simultaneously. Said cam drives said cutting tool to move periodically into said cutting cavity, and said second gear drives said first gear to rotate to drive said hollow cylinder to rotate. Meanwhile, said controlling threaded rod drives said second guide slider and said cyclic dragging ring as a whole to move to one end, and internally clamped round bars are successively pushed into said cyclic dragging ring, and said shaping tools in said hollow cylinder are started to shape the round bars. As said cyclic dragging ring is moved to one tail end of said material cavity, said cutting tool cuts off the matchsticks with corresponding length, and the formed matchsticks come out of said material returning outlet, which improves the matchmaking effect.

When the further feeding is needed, said impeller is firstly controlled to contract, and said fourth guide slider, said fifth guide slider and said third guide slider are recovered to the initial position under the action of second pushing spring, which makes said arc clamp and said slide clamp move away from each other and release the round bars, and then said motor is controlled to drive said rotating shaft to rotate reversely, and at this time said rotating shaft still drives said cutting tool and said hollow cylinder to operate, while said rotating shaft drives said controlling threaded rod which rotates reversely to make said second guide slider and said cyclic dragging ring as a whole move to the other end and recover to the initial position. Then said impeller is sequentially controlled to clamp the round bars tightly, and finally said motor is controlled to recover to rotate forward. In conclusion, reciprocating matchmaking may be realized by circulating operations above, which improves the efficiency and practical performance of the matchmaking.

The device of this invention has a simple structure and is convenient to use as it uses the same power source to realize the automatic and circulating feeding, planing operation and automatic and accurate material cutting, and all the processes are closely coordinated but not to affect their separate operation. Moreover, this device is high in automatic degree, good in matchmaking effect and saves wood, and meanwhile, the practical performance of the device is greatly improved.

The above is only the specific embodiment of the invention, but the scope of the invention is not limited thereto, and any changes or substitutions that are not thought of by the creative work should fall into the claimed protection extent of this invention. Therefore, the claimed protection extent of the invention shall be determined with reference to the appended claims.

1. An automatic matchmaking device, comprising:
a machine body,
a cylindrical machining cavity arranged in said machine body,
a material cavity with an opening towards one side communicated with an inner wall of one end of said cylindrical machining cavity,
first guide chutes which are up and down symmetrical communicated with upper and lower inner walls of said material cavity,
wherein inner walls of said first guide chutes, far away from said material cavity, are internally communicated with second guide chutes;
a first cavity which penetrates through said cylindrical machining cavity disposed in said machine body,
a cutting cavity communicated with an inner wall of the other end of said cylindrical machining cavity,
a material returning outlet which is tilted downwards communicated with an inner wall of the bottom of said cutting cavity,
second cavities which are symmetrical on upper and lower ends of said cutting cavity arranged in said machine body,
a third cavity which is on one end of said cutting cavity arranged in said machine body,
wherein said cylindrical machining cavity is internally in rotational engagement with a hollow cylinder, an inner wall of which is provided with a plurality of shaping tools;
a first gear which is fixedly connected to said hollow cylinder arranged in said first cavity which is internally in rotational engagement with rotating shafts which extend towards two ends and are up and down symmetrical,
wherein an extending tail end of one end of said rotating shaft penetrates through said second cavity and into said third cavity and the tail end of said rotating shaft is provided with a first pulley,
wherein a first belt is in power connection between two said first pulleys;
wherein an extending tail end of the other end of said rotating shaft penetrates through an inner wall of one end of said second guide chute and a controlling threaded rod extending towards two ends is fixedly connected to a tail end of said rotating shaft,
wherein an extending tail end of one end of said controlling threaded rod is in rotational engagement with the inner wall of said second guide chute;
a second gear which is used for engaging with said first gear arranged on said rotating shaft, a cam which is located in said second cavity arranged on said rotating shaft,
wherein a third guide chute is communicated between said second cavity and said cutting cavity,
wherein said third guide chute is internally in sliding fit connection with a cutting tool, one end of which, close to said second cavity, extends into said second cavity and is in power connection with said cam;
an elastic recovery device arranged on one end of said cutting tool;
cyclic material-feeding devices, used for being in power connection with said controlling threaded rods, respectively disposed in said material cavity, said first guide chutes and said second guide chute,
a dust extracting device arranged on one end face of said machine body;
wherein round bars to be machined are placed into the cyclic dragging ring, and an impeller is started to push fourth guide sliders to move towards each other, and the fourth guide sliders make an arc clamp and an slide clamp simultaneously clamp the round bars tightly, and at this time, one tail end of the round bar extends into the hollow cylinder.

2. The automatic matchmaking device as defined in claim 1, wherein an inside diameter of said shaping tool and a diameter of said cutting cavity are the same, which improves the matchmaking effect of the device.

3. The automatic matchmaking device as defined in claim 1, wherein said elastic recovery device comprises a fourth guide chute communicated with one end of said third guide chute, wherein said fourth guide chute is internally in rotational engagement with a first guide slider, wherein one end face of said first guide slider is fixedly connected to one end face of said cutting tool,
a first pushing spring which is located on a bottom of said first guide slider arranged in said fourth guide chute, so that the material may be orderly cut off;
when the cutting tool is fully contracted into the third guide chute, the first guide slider is on one end of the fourth guide chute, away from the cutting cavity, and a second guide slider is on one tail end of the second guide chute, and the fourth guide slider is on the top of the first guide chute.

4. The automatic matchmaking device as defined in claim 1, wherein said cyclic material-feeding device comprises a second guide slider which extends up and down and is in sliding fit connection with said second guide chute,
wherein said second guide slider is in threaded fit connection with said controlling threaded rod;
a cyclic dragging ring which is located on one end of said hollow cylinder fixedly connected between two said second guide sliders,
a fifth guide chute which is located in said first guide chute arranged to penetrate through said second guide slider from one side to the other side,
a push rod which extends up and down and is in sliding fit connection between said fifth guide chute and said cyclic dragging ring,
wherein one end of said push rod, close to said fifth guide chute, is fixedly connected with a third guide slider which is in sliding fit connection with said push rod,
wherein a second pushing spring is arranged between said third guide slider and an inner wall of said fifth guide chute, close to said cyclic dragging ring,
wherein one end of said push rod, close to said cyclic dragging ring, extends into interior of said cyclic dragging ring and a tail end of said push rod is provided with an arc clamp;
a fourth guide slider which penetrates through said fifth guide chute and is in sliding fit connection with said first guide chute,
wherein said fourth guide slider is in sliding fit connection with said third guide slider; a fifth guide slider which is located on one end of said second guide slider and extends up and down and is in sliding fit connection with said first guide chute,
wherein one end of said fifth guide slider, close to said fourth guide slider, is fixedly connected to said fourth guide slider;
slide clamps arranged on end faces of said fifth guide sliders, close to each other, an impeller which is used for being in power connection with said fourth guide slider embedded in the inner wall of said first guide chute, far away from said material cavity;
the second gear drives the first gear to rotate to drive the hollow cylinder to rotate; meanwhile, controlling threaded rod drives the second guide slider and the cyclic dragging ring as a whole to move to one side, which successively pushes internally clamped round bars into the cyclic dragging ring, and the shaping tools in the hollow cylinder begin to shape the round bars, so that the work efficiency of the device is improved.

5. The automatic matchmaking device as defined in claim 1, wherein a top of said machine body is provided with a fixed block, one end face of which is embedded with a motor,
wherein one tail end of said motor is in power connection with a second pulley which is located on a top of said third cavity,
wherein a second belt is in power connection between said second pulley and said first pulley;
said motor drives two said rotating shafts to rotate in the same direction, and said rotating shafts drive said cam, said second gear and said controlling threaded rod to rotate simultaneously, and said cam drives said cutting tool to periodically move into said cutting cavity.

6. The automatic matchmaking device as defined in claim 4, wherein the inside diameter of said hollow cylinder is the same as that of said cyclic dragging ring.

7. The automatic matchmaking device as defined in claim 1, wherein said dust extracting device comprises a dusting machine body which is set on one end face of said machine body, wherein said dusting machine body is internally provided with a sliding chute with an opening towards one side,
wherein said sliding chute is internally in sliding fit connection with a slider, one end face of which is provided with a dust catcher;
a second controlling threaded rod which extends towards two ends disposed on said slider,
a fourth motor in power connection with one tail end of said second controlling threaded rod,
wherein an outer surface of said fourth motor is embedded in an inner wall of one end of said sliding chute and is fixedly connected to said sliding chute, and the dust catcher may work on dust removal.
